(19) United States
(12) Patent Application Publication
(10) Pub. No.: US 2025/0193198 A1
(43) Pub. Date: Jun. 12, 2025

(54) RESOURCE ACCESS SECURITY

(71) Applicant: Capital One Services, LLC, McLean, VA (US)

(72) Inventors: Nilesh BHOYAR, Livingston, NJ (US); William CRAIN, Midlothian, VA (US); Cody MANIORD, Arlington, TX (US)

(21) Appl. No.: 18/537,142

(22) Filed: Dec. 12, 2023

(51) Int. Cl. H04L 9/40; H04L 41/22

(52) U.S. Cl. CPC H04L 63/102; H04L 41/22; H04L 63/20

(57) ABSTRACT

In some implementations, a resource access security system may obtain a plurality of identifiers of a plurality of entities, one or more indications of a plurality of resources, and one or more indications of one or more access policies that control access to the plurality of resources by the plurality of entities. The resource access security system may determine that the one or more access policies permit access to a resource, of the plurality of resources, by a first entity of the plurality of entities, via at least a second entity of the plurality of entities. The resource access security system may perform, based at least in part on determining that the one or more access policies permit access to the resource by the first entity via at least the second entity, a security action associated with the resource.

### BACKGROUND

Identity and access management (IAM) is a framework of policies and technologies designed to ensure that the appropriate users have access to technology resources. For example, IAM may help to ensure that users that are part of the ecosystem connected to or within an enterprise can access enterprise resources. IAM systems may identify, authenticate, and control resource access for users as well as hardware and applications to be accessed by the users.

### SUMMARY

Some implementations described herein relate to a system for resource access security. The system may include one or more memories and one or more processors communicatively coupled to the one or more memories. The one or more processors may be configured to obtain a plurality of identifiers of a plurality of entities. The one or more processors may be configured to obtain one or more indications of a plurality of resources. The one or more processors may be configured to obtain one or more indications of one or more access policies that control access to the plurality of resources by the plurality of entities. The one or more processors may be configured to determine, based at least in part on the plurality of identifiers, the plurality of resources, or the one or more access policies, that the one or more access policies permit access to a resource, of the plurality of resources, by a first entity of the plurality of entities, via at least a second entity of the plurality of entities. The one or more processors may be configured to perform, based at least in part on determining that the one or more access policies permit access to the resource by the first entity via at least the second entity, a security action associated with the resource.

Some implementations described herein relate to a method of resource access security. The method may include obtaining a plurality of identifiers of a plurality of entities. The method may include obtaining one or more indications of a plurality of resources. The method may include obtaining one or more indications of one or more access policies that control access to the plurality of resources by the plurality of entities. The method may include determining, based at least in part on the plurality of identifiers, the plurality of resources, or the one or more access policies, that the one or more access policies permit access to a resource, of the plurality of resources, by a first entity of the plurality of entities, via at least a second entity of the plurality of entities. The method may include displaying, based at least in part on determining that the one or more access policies permit access to the resource by the first entity via at least the second entity, a graphical representation associated with the access to the resource by the first entity.

Some implementations described herein relate to a non-transitory computer-readable medium that stores a set of instructions. The set of instructions comprise one or more instructions that, when executed by one or more processors of a resource access security system, may cause the resource access security system to obtain a plurality of identifiers of a plurality of entities. The one or more instructions, when executed by one or more processors of the resource access security system, may cause the resource access security system to obtain one or more indications of a plurality of resources. The one or more instructions, when executed by one or more processors of the resource access security system, may cause the resource access security system to obtain one or more indications of one or more access policies that control access to the plurality of resources by the plurality of entities. The one or more instructions, when executed by one or more processors of the resource access security system, may cause the resource access security system to determine, based at least in part on the plurality of identifiers, the plurality of resources, or the one or more access policies, that the one or more access policies permit access to a resource, of the plurality of resources, by a first entity of the plurality of entities, via at least a second entity of the plurality of entities. The one or more instructions, when executed by one or more processors of the resource access security system, may cause the resource access security system to perform, based at least in part on determining that the one or more access policies permit access to the resource by the first entity via at least the second entity, a security action associated with the resource.

### BRIEF DESCRIPTION OF THE DRAWINGS

FIG. 1 is a diagram of an example associated with resource access security, in accordance with some embodiments of the present disclosure.

FIG. 2 is a diagram of an example associated with secondary access paths, in accordance with some embodiments of the present disclosure.

FIG. 3 is a diagram of an example associated with access policies that control access to a target resource, in accordance with some embodiments of the present disclosure.

FIG. 4 is a diagram of an example associated with data sources associated with resource access security, in accordance with some embodiments of the present disclosure.

FIG. 5 is a diagram of an example associated with a graphical representation in an asset view, in accordance with some embodiments of the present disclosure.

FIG. 6 is a diagram of an example associated with associated with a graphical representation in an associate view, in accordance with some embodiments of the present disclosure.

FIG. 7 is a diagram of an example environment in which systems and/or methods described herein may be implemented, in accordance with some embodiments of the present disclosure.

FIG. 8 is a diagram of example components of a device associated with resource access security, in accordance with some embodiments of the present disclosure.

FIG. 9 is a flowchart of an example process associated with resource access security, in accordance with some embodiments of the present disclosure.

### DETAILED DESCRIPTION

The following detailed description of example implementations refers to the accompanying drawings. The same reference numbers in different drawings may identify the same or similar elements.

With the advent of cloud technologies, users can access resources via not only primary (e.g., direct) access, but also via layered access paths. Layered access paths may include secondary paths (e.g., access via one server, virtual machine, or the like), tertiary paths (e.g., access via two servers, virtual machines, or the like), quaternary access (e.g., access via three servers, virtual machines, or the like), quinary access (e.g., access via four servers, virtual machines, or the like), and so forth. Layered access paths may involve any suitable level of access to the resource. For example, an associate (e.g., a human) who does not have access to particular cloud resource or asset (e.g., a dataset), but can access a server that has access to the cloud resource, may access the cloud resource via the server (e.g., via a secondary path). Cloud providers may offer IAM modules (e.g., cloud access modules) used to create and govern access within cloud environments. These IAM modules are designed to provide transparency for individual logical units (e.g., accounts) of an access ecosystem, but fail to track layered access patterns. As a result, these IAM modules may be unable to identify the entirety of the access ecosystem. For example, IAM modules may be unable to confirm which users have access to particular cloud resources, detect over-privileges, join privileges in other access tools, or test regulatory compliance.

Some implementations described herein enable a resource access security system (e.g., an access transparency engine) to monitor layered access paths. In one phase, the resource access security system may combine data across several data sources, such as identity solutions, resource access control lists (ACLs) in the cloud, cloud roles, policies, enterprise identity stores, cloud providers (which may maintain IAM solutions that include roles, permissions and policies), or the like. The resource access security system may obtain identities (e.g., identifiers), clean up the identities, remove duplicated identities, and correlate the identities with user (e.g., human) identities to identify actors in a system. In another phase, the resource access security system may aggregate resources (e.g., assets) from among cloud and non-cloud resources. The resource access security system may tag the resources against applications and identify overlapping or related categories or resources or applications.

The resource access security system may use a correlation engine to correlate the identities with the resources based on which identities can access which resources (e.g., using primary or layered access paths/patterns). In some examples, the resource access security system may map these access patterns into graphs (which may be referred to as “access knowledge graphs”), which may be displayed for visualization of resource access via primary or layered access paths. In some examples, the resource access security system may execute a security action based on the access patterns (e.g., removing user access to a resource).

As a result, the resource access security system may determine an overall resource footprint (e.g., a resource footprint that accounts for layered access paths). For example, the resource access security system may determine which users have direct access to cloud resources, secondary access to cloud resources, and/or tertiary access to cloud resources. Thus, based on the layered access paths, the resource access security system may confirm which users have access to particular cloud resources, detect over-privileges, join privileges in other access tools, test regulatory compliance, or the like.

For example, an access knowledge graph may show layered access paths, which may improve resource access security (e.g., the display of the layered access paths may help to resolve a past breach and/or may proactively control resource access). Additionally, or alternatively, the security action executed by the resource access security system may help to improve security with respect to access of resources. For example, the resource access security system may execute edge case analysis on an access knowledge graph to identify any users that have outlier (e.g., excessive) access to particular cloud resources. The resource access security system may remove access to the resources, thereby mitigating exposure to rogue access (or unnecessary risk of rogue access) and improving cybersecurity and/or helping to ensure compliance with relevant regulations.

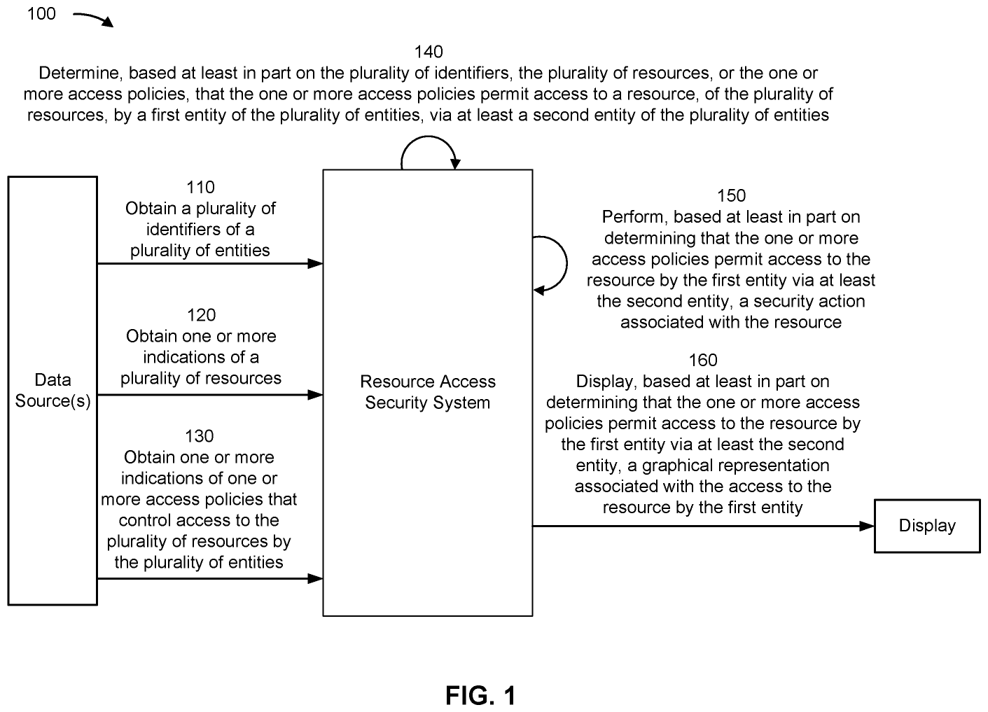

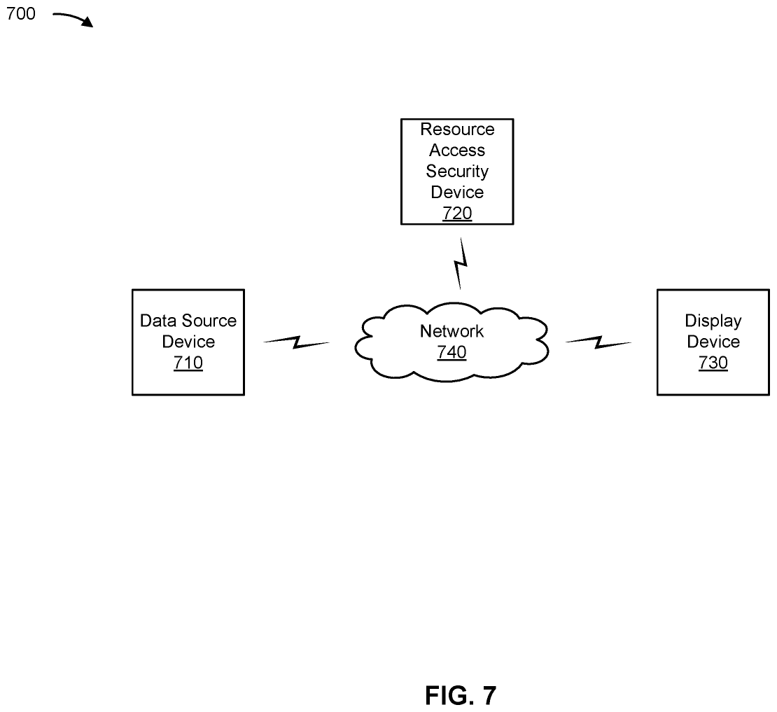

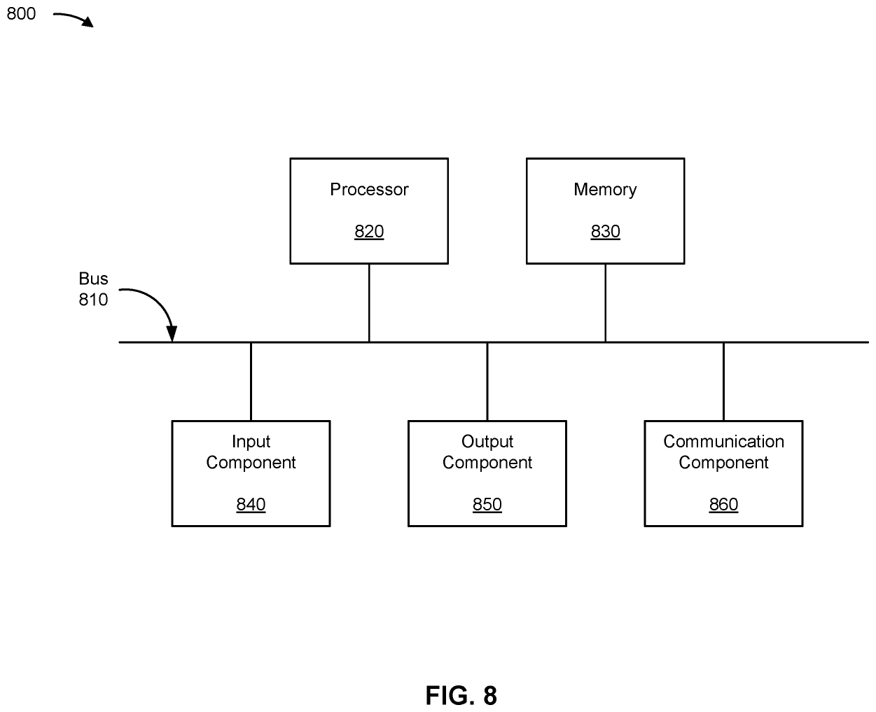

FIG. 1 is a diagram of an example 100 associated with resource access security. As shown in FIG. 1, example 100 includes one or more data sources, a resource access security system, and a display. These devices are described in more detail in connection with FIGS. 7 and 8.

As shown by reference number 110, the resource access security system may obtain, from the data source(s), a plurality of identifiers of a plurality of entities. Each entity may be associated with a user (e.g., a human), a server (e.g., a virtual server, a virtual machine, a virtual computer, or the like), or a system account (e.g., a bot, a cloud provider account associated with the user, or the like), among other examples.

As shown by reference number 120, the resource access security system may obtain, from the data source(s), one or more indications of a plurality of resources. Each resource may be associated with an application, a data store, or the like. For example, the resource may be the application, or the resource may be contained in the data store.

As shown by reference number 130, the resource access security system may obtain, from the data source(s), one or more indications of one or more access policies that control access to the plurality of resources by the plurality of entities. For example, the access policies may permit, or prohibit, access by one or more of the entities with respect to one or more of the resources.

As shown by reference number 140, the resource access security system may determine, based at least in part on the plurality of identifiers, the plurality of resources, or the one or more access policies, that the one or more access policies permit access to a resource, of the plurality of resources, by a first entity of the plurality of entities, via at least a second entity of the plurality of entities. For example, the resource access security system may determine that the one or more access policies permit secondary access to the resource.

In some aspects, the resource access security system may determine that the one or more access policies permit access to the resource by the first entity via at least the second entity and via at least a third entity of the plurality of entities. For example, the resource access security system may determine that the one or more access policies permit tertiary access to the resource. Additionally, or alternatively, the resource access security system may determine that the one or more access policies permit quaternary access, quinary access, or any other suitable level of access to the resource.

As shown by reference number 150, the resource access security system may perform, based at least in part on determining that the one or more access policies permit access to the resource by the first entity via at least the second entity, a security action associated with the resource. In some aspects, the resource access security system may obtain, from the data source(s), a plurality of access logs. In some examples, the access logs may indicate how often the first entity accessed the resource via the second entity. Based on the plurality of access logs, the resource access security system may remove (e.g., autonomously or in conjunction with a network administrator) access to the resource by the first entity via at least the second entity (e.g., using machine learning). For example, the resource access security system may remove secondary access of the resource by the first entity based on the first entity accessing the resource via the second entity infrequently (e.g., based on a quantity of accesses of the resource by the first entity not satisfying an access frequency threshold).

In some examples, the resource access security system may perform a security action that includes providing access (e.g., primary or layered access) to a resource by an entity. For instance, the resource access security system may add (e.g., autonomously or in conjunction with a network administrator) an access path to enable an entity to access a resource. In some examples, the resource access security system may perform a security action that includes mitigating a security breach. For instance, the resource access security system may determine (e.g., autonomously or in conjunction with a network administrator) that a secondary or tertiary access path was used for unauthorized access of a resource.

As shown by reference number 160, the resource access security system may display, based at least in part on determining that the one or more access policies permit access to the resource by the first entity via at least the second entity, a graphical representation associated with the access to the resource by the first entity. For example, the graphical representation may include a plurality of nodes and a plurality of edges, where each node represents an entity or a resource and each edge represents access of a resource by an entity. In some aspects, the graphical representation may include at least a first node associated with the resource, a second node associated with the first entity, and an edge associated with the access to the resource by the first entity.

In some examples, the resource access security system may perform the operations shown by reference numbers 150 and 160 in parallel or sequentially in any suitable order. In some examples, the resource access security system may perform only one of the operations shown by reference numbers 150 and 160.

Performing the security action may help to improve the security of a resource. For example, removing access to a resource may proactively mitigate risk of unauthorized access to the resource. Providing access to a resource may enable an entity to access a resource in a controlled environment via an authorized access path. Mitigating a security breach may help to improve response time to a security breach and thereby minimize damage due to unauthorized access of a resource. Displaying the graphical representation (e.g., displaying a layered access path) may improve resource access security. For example, the graphical representation may help to resolve a past security breach and/or may proactively control resource access. In some examples, displaying the graphical representation may help to identify restrictive access rights for a specific workload and, in some cases, lessen the restrictions (or further restrict the access rights).

As indicated above, FIG. 1 is provided as an example. Other examples may differ from what is described with regard to FIG. 1.

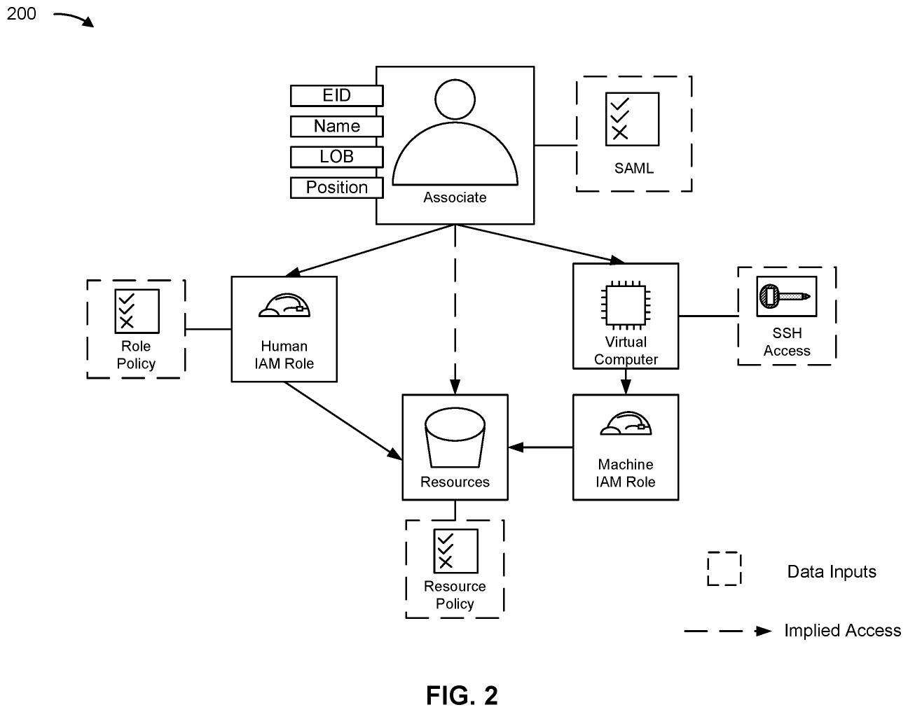

FIG. 2 is a diagram of an example 200 associated with secondary access paths. As shown in FIG. 2, example 200 includes an associate who does not have direct/primary access to a set of resources but does have secondary access to the resources. The associate is associated with attributes (e.g., search attributes), including an electronic identification (EID), a name, a line of business (LOB), and a position (e.g., “Manager”).

The associate can access the resources via two secondary access paths. In one secondary access path, the associate can access the resources via a human IAM role. For example, based on a security assertion markup language (SAML) assertion, a role policy, and/or the EID, the associate may assume the human IAM role and thereby access the resources. In another secondary access path, the associate can access the resources via a virtual computer (e.g., a virtual computer instance). For example, the associate may access the virtual computer using secure shell protocol (SSH) keys, and the virtual computer may access the resources based on a resource policy.

The resource access security system may obtain data inputs including the SAML assertion, the role policy, the SSH keys, and the resource policy. Based on the data inputs, the resource access security system may determine that the associate has secondary access to the resources via at least two secondary access paths. Based on the secondary access paths, the resource access security system may perform (e.g., execute) a security action with respect to the resource and/or display a graphical representation of the secondary access paths.

As indicated above, FIG. 2 is provided as an example. Other examples may differ from what is described with regard to FIG. 2.

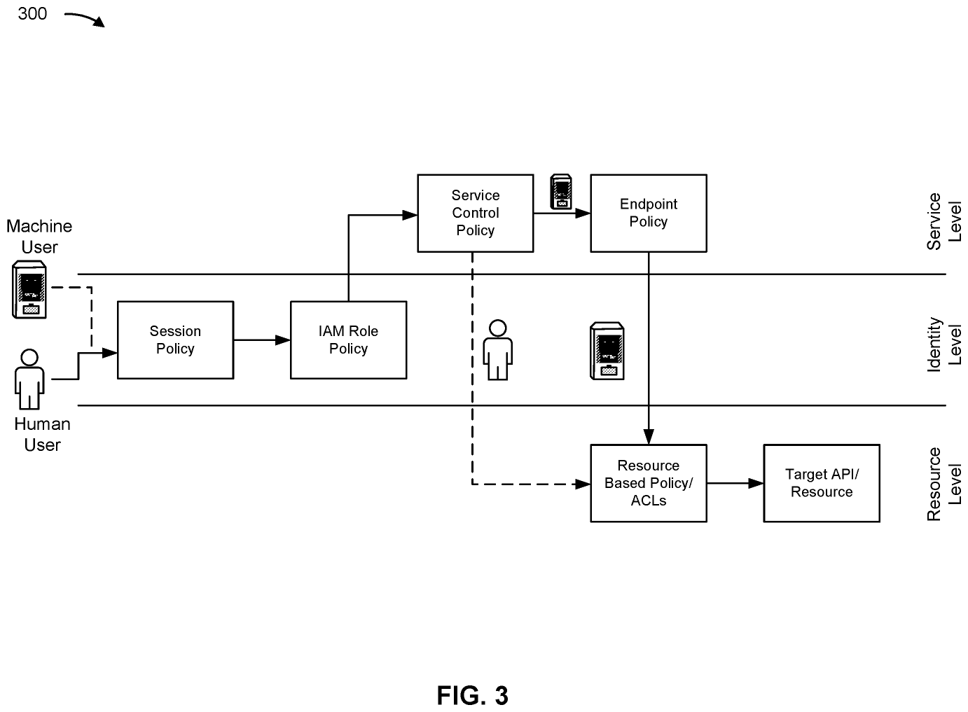

FIG. 3 is a diagram of an example 300 associated with access policies that control access to a target resource. As shown in FIG. 3, example 300 includes five access policies that shape access patterns with respect to a target resource (e.g., a deployed cloud resource, such as a target application programming interface (API)) by a machine user and a human user. The access policies include a session policy, an IAM role policy, a service control policy, an endpoint policy, and a resource-based policy (e.g., ACLs). As shown, the session and IAM role policies are identity-level policies, the service control and endpoint policies are service-level policies, and the resource-based policy is a resource-level policy.

The resource access security system may (e.g., unlike a human network administrator) determine whether, and to what extent, the access policies allow access to the target resource. For example, using data analytics, the resource access security system may determine access grants by evaluating multiple policy statements that allow or deny access to a resource. For example, the resource access security system may determine whether the machine user and/or the human user are permitted to perform actions on the target resource. For example, the resource access security system may determine whether the machine user and/or the human user can access the target resource via a layered access path.

The resource access security system may perform a security action and/or display a graphical representation of the access. For example, the resource access security system may present a comprehensible view of the access that results from the five access policies. In some examples, the resource access security system may show what access is allowed based on the access policies and what access is used based on access logs.

As indicated above, FIG. 3 is provided as an example. Other examples may differ from what is described with regard to FIG. 3.

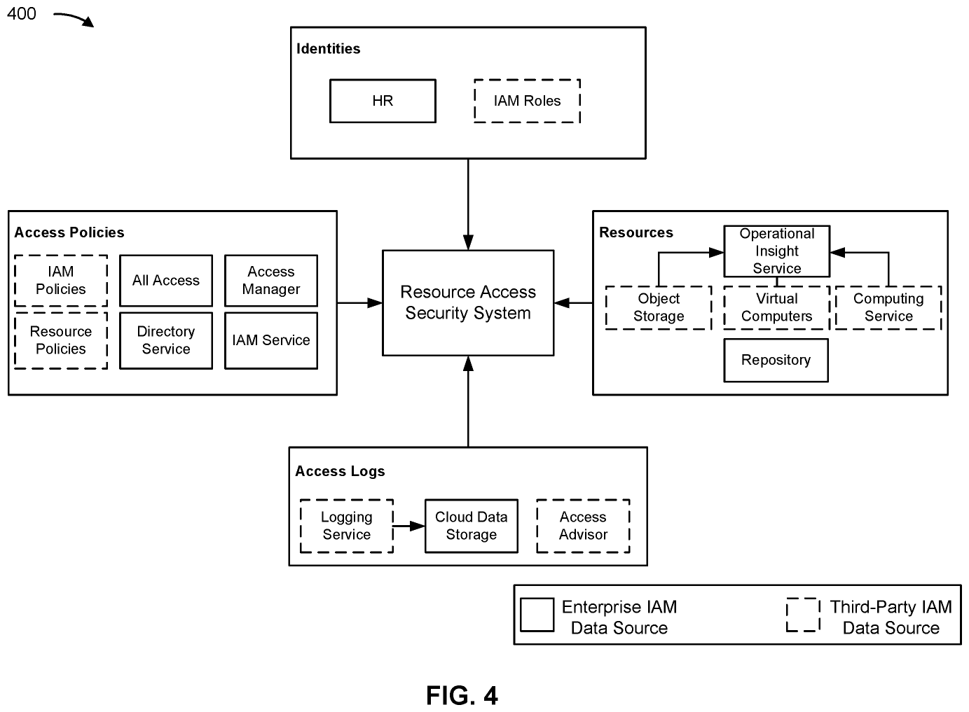

FIG. 4 is a diagram of an example 400 associated with data sources associated with resource access security. As shown in FIG. 4, the resource access security system may obtain data associated with identities, access policies, resources, and/or access logs. The identities may include identifiers of entities (e.g., humans, machines, system accounts, or the like). The access policies may indicate accesses or permissions associated with one or more resources. The resources may include datasets, applications, or the like. The access logs (e.g., usage logs) may indicate which access paths are used.

In some aspects, the plurality of entities, the plurality of resources, the one or more access policies, and the data source(s) may be associated with an enterprise. For example, as shown, some of the data sources may be enterprise IAM data sources. Other data sources may be third-party (e.g., cloud provider) IAM data sources. The resource access security system may correlate data obtained from both the enterprise and the cloud provider, which may enable access transparency. For example, by correlating the data, the resource access security system may identify layered access paths.

As indicated above, FIG. 4 is provided as an example. Other examples may differ from what is described with regard to FIG. 4.

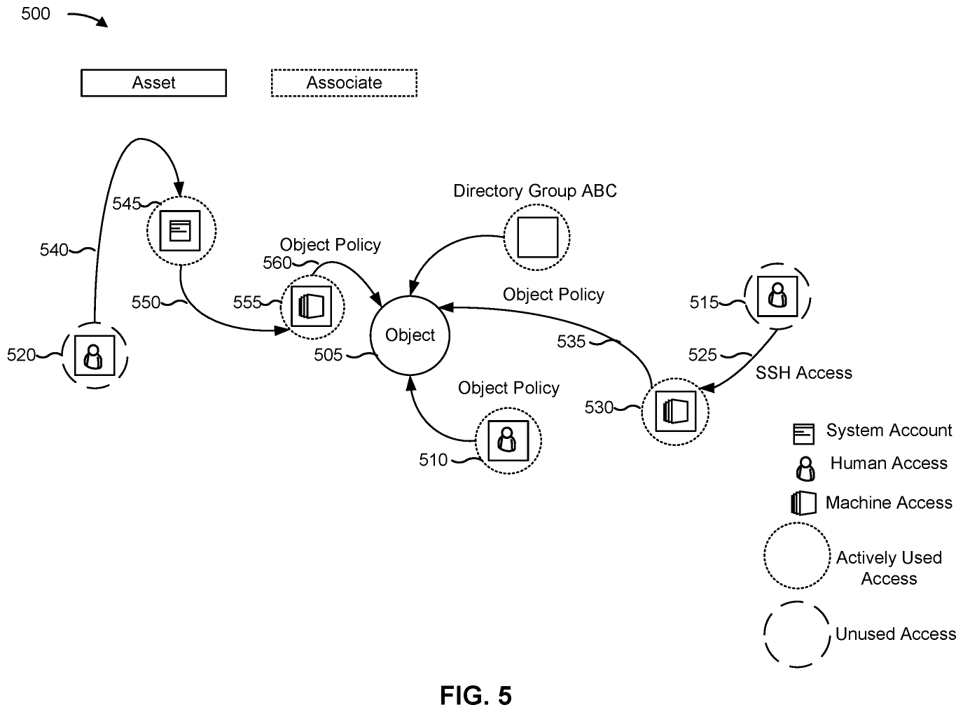

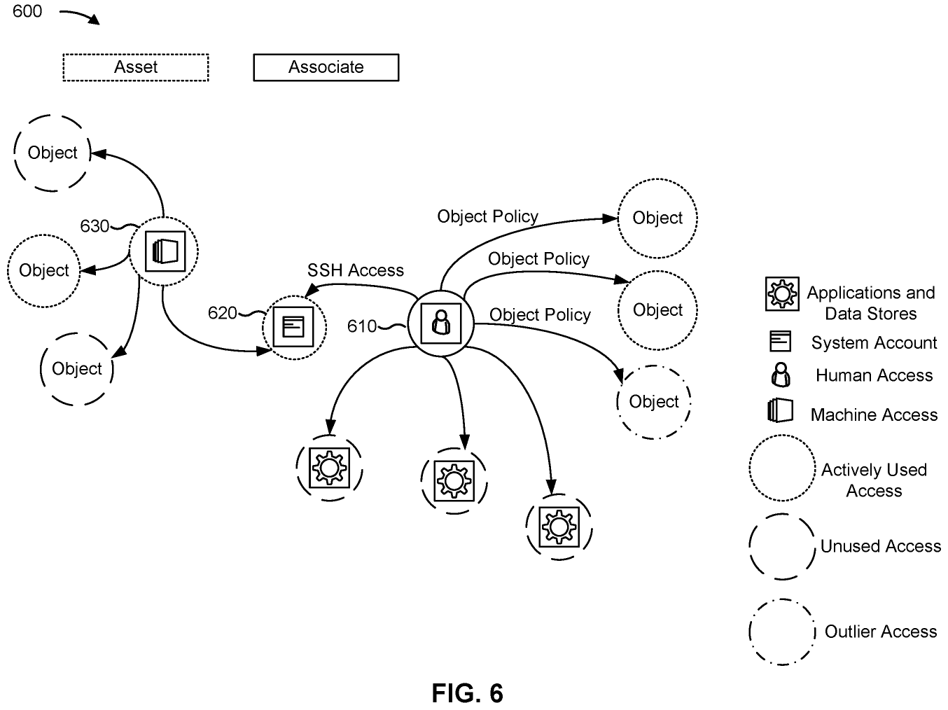

FIGS. 5 and 6 illustrate graphical representations associated with access to a resource. The resource access security system may construct and display the graphical representations based on data obtained from one or more data sources (e.g., as described above in connection with FIG. 4). The resource access security system may generate or update the graphical representations in response to a network administrator prompt, a change in data obtained from the data sources (e.g., in case data is removed, data is added, or data is replaced or altered), or the like. The graphical representations may include a plurality of nodes and a plurality of edges, where each node represents an entity or a resource and each edge represents access of a resource by an entity.

FIG. 5 is a diagram of an example 500 associated with a graphical representation in an asset view. An asset view may be resource-centric (e.g., the asset view may contain a resource and one or more entities with access to that resource). In some aspects, a node 505 is associated with (e.g., represents) a resource (e.g., an object), and the remaining nodes are associated with respective entities (e.g., system accounts, humans, machines, directory groups, or the like). For example, a node 510 is associated with (e.g., represents) a human with primary access to the resource, a node 515 is associated with a human with secondary access to the resource (e.g., via one machine), and node 520 is associated with a human with tertiary access to the resource (e.g., via one system account and one machine).

The graphical representation also contains edges (e.g., constructed based on the access policies) that are associated with access to the resource by various entities (e.g., the edges may represent which entities can access the resource associated with node 505). For example, edges may represent object policies, SSH access, or the like. The edge connecting nodes 505 and 510 indicates that the human associated with node 510 has primary access to the resource associated with node 505. The edges connecting nodes 505 and 515 indicate that the human associated with node 515 has secondary access to the resource associated with node 505. For example, the edge 525 may be associated with (e.g., connect) node 515 and a node 530 associated with a machine, and the edge 535 may be associated with the node 530 and the node 505. The edges connecting nodes 505 and 520 indicate that the human associated with node 520 has tertiary access to the resource associated with node 505. For example, the edge 540 may be associated with (e.g., connect) node 520 and a node 545 associated with a system account, the edge 550 may be associated with the node 545 and a node 555 associated with a machine, and the edge 560 may be associated with the node 555 and the node 505.

In some examples, the resource access security system may correlate access logs with other data sources to determine which edges to remove to minimize an access privilege, thereby improving security. For example, based on the access logs, the resource access security system may determine that the human associated with node 515 does not access the resource associated with the node 505 using the secondary access path shown in FIG. 5. As a result, in some examples, the resource access security system may remove the edge 525 (e.g., the resource access security system may remove access to the machine associated with the node 530 by the human associated with the node 515). The resource access security system may also determine that the human associated with node 520 does not access the resource associated with the node 505 using the tertiary access path shown in FIG. 5. As a result, the resource access security system may remove the edge 540 (e.g., the resource access security system may remove access to the system account associated with the node 545 by the human associated with the node 520).

As indicated above, FIG. 5 is provided as an example. Other examples may differ from what is described with regard to FIG. 5.

FIG. 6 is a diagram of an example 600 associated with associated with a graphical representation in an associate view. An associate view may be entity-centric (e.g., the associate view may contain an entity and any resources that are accessible by that entity). In some aspects, a node 610 is associated with (e.g., represents) a human entity, a node 620 is associated with a system account entity, a node 630 is associated with a machine entity, and the remaining nodes are associated with respective resources (e.g., applications or data stores). The graphical representation also contains edges (e.g., constructed based on the access policies) that are associated with access to various resources by the entities associated with node 610, node 620, or node 630.

In some examples, the resource access security system may correlate access logs with other data sources to determine which edges to remove minimize access privilege, thereby improving security. For example, based on the access logs, the resource access security system may determine that the human associated with node 610 does not access the applications and data stores. As a result, in some examples, the resource access security system may remove the edges connecting the node 610 with the nodes associated with the applications and data stores (e.g., the resource access security system may remove access to the applications and data stores by the human associated with the node 610).

The resource access security system may also determine that the human associated with node 610 having access to one of the resources (e.g., an object) is an outlier. For example, the resource access security system may determine that this access is an outlier using machine learning and based on data relating to access of resources by entities. In some examples, the data may relate to entities that are permitted to access (and/or actually access) the resource and/or similar resources. In some examples, the data may relate to resources that can be accessed by (and/or are actually accessed by) the entity and/or similar entities. The resource access security system may remove the edge connecting the node 610 with the node associated with the resource (e.g., the resource access security system may remove access to the resource by the human associated with the node 610).

As indicated above, FIG. 6 is provided as an example. Other examples may differ from what is described with regard to FIG. 6.

FIG. 7 is a diagram of an example environment 700 in which systems and/or methods described herein may be implemented. As shown in FIG. 7, environment 700 may include a data source device 710, a resource access security device 720, a display device 730, and a network 740. Devices of environment 700 may interconnect via wired connections, wireless connections, or a combination of wired and wireless connections.

The data source device 710 may include one or more devices capable of receiving, generating, storing, processing, and/or providing information associated with resource access security, as described elsewhere herein. The data source device 710 may include a communication device and/or a computing device. For example, the data source device 710 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The data source device 710 may communicate with one or more other devices of environment 700, as described elsewhere herein.

The resource access security device 720 may include one or more devices capable of receiving, generating, storing, processing, providing, and/or routing information associated with resource access security, as described elsewhere herein. The resource access security device 720 may include a communication device and/or a computing device. For example, the resource access security device 720 may include a server, such as an application server, a client server, a web server, a database server, a host server, a proxy server, a virtual server (e.g., executing on computing hardware), or a server in a cloud computing system. In some implementations, the resource access security device 720 may include computing hardware used in a cloud computing environment. In some examples, the resource access security device 720 may comprise the resource access security system shown in FIG. 1.

The display device 730 may include any suitable device capable of displaying information associated with resource access security, as described elsewhere herein. The display device 730 may be a standalone device or integrated into another device (e.g., the resource access security device 720). The display device 730 may include a communication device and/or a computing device. The display device 730 may include an electronic display (e.g., a screen), such as a liquid crystal display, a light-emitting diode display, or the like.

The network 740 may include one or more wired and/or wireless networks. For example, the network 740 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 740 enables communication among the devices of environment 700.

The number and arrangement of devices and networks shown in FIG. 7 are provided as an example. In practice, there may be additional devices and/or networks, fewer devices and/or networks, different devices and/or networks, or differently arranged devices and/or networks than those shown in FIG. 7. Furthermore, two or more devices shown in FIG. 7 may be implemented within a single device, or a single device shown in FIG. 7 may be implemented as multiple, distributed devices. Additionally, or alternatively, a set of devices (e.g., one or more devices) of environment 700 may perform one or more functions described as being performed by another set of devices of environment 700.

FIG. 8 is a diagram of example components of a device 800 associated with resource access security. The device 800 may correspond to data source device 710, resource access security device 720, and/or display device 730. In some implementations, data source device 710, resource access security device 720, and/or display device 730 may include one or more devices 800 and/or one or more components of the device 800. As shown in FIG. 8, the device 800 may include a bus 810, a processor 820, a memory 830, an input component 840, an output component 850, and/or a communication component 860.

The bus 810 may include one or more components that enable wired and/or wireless communication among the components of the device 800. The bus 810 may couple together two or more components of FIG. 8, such as via operative coupling, communicative coupling, electronic coupling, and/or electric coupling. For example, the bus 810 may include an electrical connection (e.g., a wire, a trace, and/or a lead) and/or a wireless bus. The processor 820 may include a central processing unit, a graphics processing unit, a microprocessor, a controller, a microcontroller, a digital signal processor, a field-programmable gate array, an application-specific integrated circuit, and/or another type of processing component. The processor 820 may be implemented in hardware, firmware, or a combination of hardware and software. In some implementations, the processor 820 may include one or more processors capable of being programmed to perform one or more operations or processes described elsewhere herein.

The memory 830 may include volatile and/or nonvolatile memory. For example, the memory 830 may include random access memory (RAM), read only memory (ROM), a hard disk drive, and/or another type of memory (e.g., a flash memory, a magnetic memory, and/or an optical memory). The memory 830 may include internal memory (e.g., RAM, ROM, or a hard disk drive) and/or removable memory (e.g., removable via a universal serial bus connection). The memory 830 may be a non-transitory computer-readable medium. The memory 830 may store information, one or more instructions, and/or software (e.g., one or more software applications) related to the operation of the device 800. In some implementations, the memory 830 may include one or more memories that are coupled (e.g., communicatively coupled) to one or more processors (e.g., processor 820), such as via the bus 810. Communicative coupling between a processor 820 and a memory 830 may enable the processor 820 to read and/or process information stored in the memory 830 and/or to store information in the memory 830.

The input component 840 may enable the device 800 to receive input, such as user input and/or sensed input. For example, the input component 840 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 850 may enable the device 800 to provide output, such as via a display, a speaker, and/or a light-emitting diode. The communication component 860 may enable the device 800 to communicate with other devices via a wired connection and/or a wireless connection. For example, the communication component 860 may include a receiver, a transmitter, a transceiver, a modem, a network interface card, and/or an antenna.

The device 800 may perform one or more operations or processes described herein. For example, a non-transitory computer-readable medium (e.g., memory 830) may store a set of instructions (e.g., one or more instructions or code) for execution by the processor 820. The processor 820 may execute the set of instructions to perform one or more operations or processes described herein. In some implementations, execution of the set of instructions, by one or more processors 820, causes the one or more processors 820 and/or the device 800 to perform one or more operations or processes described herein. In some implementations, hardwired circuitry may be used instead of or in combination with the instructions to perform one or more operations or processes described herein. Additionally, or alternatively, the processor 820 may be configured to perform one or more operations or processes described herein. Thus, implementations described herein are not limited to any specific combination of hardware circuitry and software.

The number and arrangement of components shown in FIG. 8 are provided as an example. The device 800 may include additional components, fewer components, different components, or differently arranged components than those shown in FIG. 8. Additionally, or alternatively, a set of components (e.g., one or more components) of the device 800 may perform one or more functions described as being performed by another set of components of the device 800.

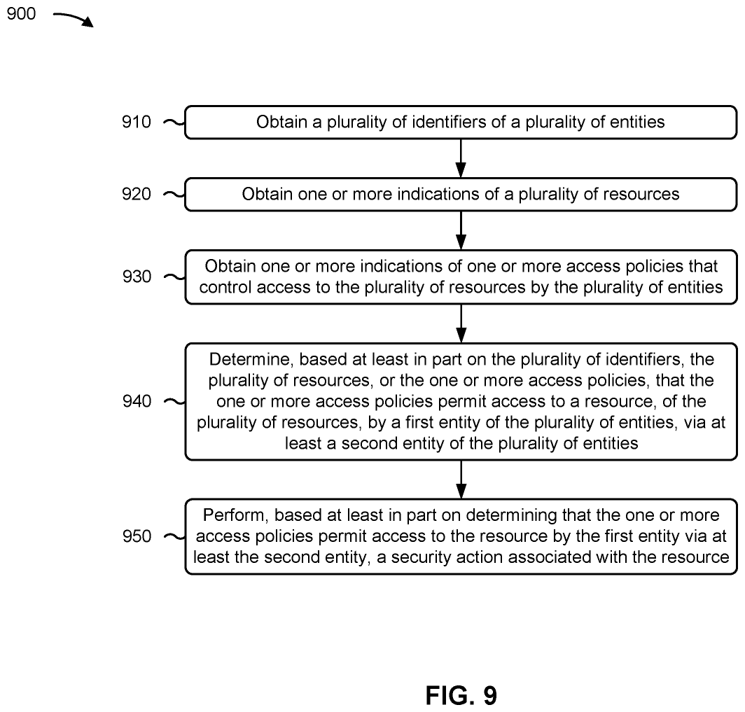

FIG. 9 is a flowchart of an example process 900 associated with resource access security. In some implementations, one or more process blocks of FIG. 9 may be performed by the resource access security device 720. In some implementations, one or more process blocks of FIG. 9 may be performed by another device or a group of devices separate from or including the resource access security device 720, such as the data source device 710, and/or the display device 730. Additionally, or alternatively, one or more process blocks of FIG. 9 may be performed by one or more components of the device 800, such as processor 820, memory 830, input component 840, output component 850, and/or communication component 860.

As shown in FIG. 9, process 900 may include obtaining a plurality of identifiers of a plurality of entities (block 910). For example, the resource access security device 720 (e.g., using processor 820 and/or memory 830) may obtain a plurality of identifiers of a plurality of entities, as described above in connection with reference number 110 of FIG. 1. As an example, the entities may include users, servers, and/or system accounts.

As further shown in FIG. 9, process 900 may include obtaining one or more indications of a plurality of resources (block 920). For example, the resource access security device 720 (e.g., using processor 820 and/or memory 830) may obtain one or more indications of a plurality of resources, as described above in connection with reference number 120 of FIG. 1. As an example, the resources may include applications and/or data stores.

As further shown in FIG. 9, process 900 may include obtaining one or more indications of one or more access policies that control access to the plurality of resources by the plurality of entities (block 930). For example, the resource access security device 720 (e.g., using processor 820 and/or memory 830) may obtain one or more indications of one or more access policies that control access to the plurality of resources by the plurality of entities, as described above in connection with reference number 130 of FIG. 1. As an example, the access policies may control whether one or more of the users, servers, and/or system accounts are permitted to access one or more of the applications and/or data stores.

As further shown in FIG. 9, process 900 may include determining, based at least in part on the plurality of identifiers, the plurality of resources, or the one or more access policies, that the one or more access policies permit access to a resource, of the plurality of resources, by a first entity of the plurality of entities, via at least a second entity of the plurality of entities (block 940). For example, the resource access security device 720 (e.g., using processor 820 and/or memory 830) may determine, based at least in part on the plurality of identifiers, the plurality of resources, or the one or more access policies, that the one or more access policies permit access to a resource, of the plurality of resources, by a first entity of the plurality of entities, via at least a second entity of the plurality of entities, as described above in connection with reference number 140 of FIG. 1. As an example, the resource access security device 720 may determine that the first entity has secondary or tertiary access to the resource.

As further shown in FIG. 9, process 900 may include performing, based at least in part on determining that the one or more access policies permit access to the resource by the first entity via at least the second entity, a security action associated with the resource (block 950). For example, the resource access security device 720 (e.g., using processor 820 and/or memory 830) may perform, based at least in part on determining that the one or more access policies permit access to the resource by the first entity via at least the second entity, a security action associated with the resource, as described above in connection with reference number 150 of FIG. 1. As an example, the resource access security device 720 may remove access to the resource by the first entity via at least the second entity.

Although FIG. 9 shows example blocks of process 900, in some implementations, process 900 may include additional blocks, fewer blocks, different blocks, or differently arranged blocks than those depicted in FIG. 9. Additionally, or alternatively, two or more of the blocks of process 900 may be performed in parallel. The process 900 is an example of one process that may be performed by one or more devices described herein. These one or more devices may perform one or more other processes based on operations described herein, such as the operations described in connection with FIGS. 1-6. Moreover, while the process 900 has been described in relation to the devices and components of the preceding figures, the process 900 can be performed using alternative, additional, or fewer devices and/or components. Thus, the process 900 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for resource access security, the system comprising:
one or more memories; and
one or more processors, communicatively coupled to the one or more memories, configured to:
obtain a plurality of identifiers of a plurality of entities;
obtain one or more indications of a plurality of resources;
obtain one or more indications of one or more access policies that control access to the plurality of resources by the plurality of entities;
determine, based at least in part on the plurality of identifiers, the plurality of resources, or the one or more access policies, that the one or more access policies permit access to a resource, of the plurality of resources, by a first entity of the plurality of entities, via at least a second entity of the plurality of entities; and
perform, based at least in part on determining that the one or more access policies permit access to the resource by the first entity via at least the second entity, a security action associated with the resource.

2. The system of claim 1, wherein the one or more processors are further configured to:
obtain a plurality of access logs, wherein the one or more processors, to perform the security action, are configured to:
remove, based on the plurality of access logs, access to the resource by the first entity via at least the second entity.

3. The system of claim 2, wherein the one or more processors, to remove the access to the resource by the first entity via at least the second entity, are configured to:
remove the access to the resource by the first entity via at least the second entity using machine learning.

4. The system of claim 1, wherein the one or more processors, to determine that the one or more access policies permit access to the resource by the first entity via at least the second entity, are configured to:
determine that the one or more access policies permit access to the resource by the first entity via at least the second entity and via at least a third entity of the plurality of entities.

5. The system of claim 1, wherein the plurality of entities, the plurality of resources, and the one or more access policies are associated with an enterprise, and wherein the one or more processors, to obtain the plurality of identifiers, the one or more indications of the plurality of resources, and the one or more indications of the one or more access policies, are configured to:
obtain the plurality of identifiers, the one or more indications of the plurality of resources, and the one or more indications of the one or more access policies from one or more data sources associated with the enterprise.

6. The system of claim 1, wherein each entity, of the plurality of entities, is associated with a user, a server, or a system account.

7. The system of claim 1, wherein each resource, of the plurality of resources, is associated with an application or a data store.

8. A method of resource access security, comprising:
obtaining a plurality of identifiers of a plurality of entities;
obtaining one or more indications of a plurality of resources;
obtaining one or more indications of one or more access policies that control access to the plurality of resources by the plurality of entities;
determining, based at least in part on the plurality of identifiers, the plurality of resources, or the one or more access policies, that the one or more access policies permit access to a resource, of the plurality of resources, by a first entity of the plurality of entities, via at least a second entity of the plurality of entities; and
displaying, based at least in part on determining that the one or more access policies permit access to the resource by the first entity via at least the second entity, a graphical representation associated with the access to the resource by the first entity.

9. The method of claim 8, wherein displaying the graphical representation includes displaying at least a first node associated with the resource, a second node associated with the first entity, and an edge associated with the access to the resource by the first entity.

10. The method of claim 9, wherein displaying the graphical representation further includes displaying a third node associated with the second entity, and wherein displaying the edge includes displaying a first edge associated with the first node and the third node, the method further comprising:
displaying a second edge associated with the third node and the second node.

11. The method of claim 9, wherein displaying the graphical representation includes displaying:
the first node,
a plurality of second nodes, including the second node, wherein the plurality of second nodes is associated with a plurality of first entities of the plurality of entities, and wherein the plurality of first entities includes the first entity, and
a plurality of edges, including the edge, associated with access to the resource by the plurality of first entities.

12. The method of claim 9, wherein displaying the graphical representation includes displaying:
a plurality of first nodes, including the first node, wherein the plurality of first nodes is associated with the plurality of resources,
the second node, and
a plurality of edges, including the edge, associated with access to the plurality of resources by the first entity.

13. The method of claim 8, wherein displaying the graphical representation includes displaying an indication that the first entity is associated with a user, a server, or a system account.

14. The method of claim 8, wherein displaying the graphical representation includes displaying an indication that the resource is associated with an application or a data store.

15. A non-transitory computer-readable medium storing a set of instructions, the set of instructions comprising:
one or more instructions that, when executed by one or more processors of a resource access security system, cause the resource access security system to:
obtain a plurality of identifiers of a plurality of entities;
obtain one or more indications of a plurality of resources;
obtain one or more indications of one or more access policies that control access to the plurality of resources by the plurality of entities;
determine, based at least in part on the plurality of identifiers, the plurality of resources, or the one or more access policies, that the one or more access policies permit access to a resource, of the plurality of resources, by a first entity of the plurality of entities, via at least a second entity of the plurality of entities; and
perform, based at least in part on determining that the one or more access policies permit access to the resource by the first entity via at least the second entity, a security action associated with the resource.

16. The non-transitory computer-readable medium of claim 15, wherein the one or more instructions further cause the resource access security system to:
display, based at least in part on determining that the one or more access policies permit access to the resource by the first entity via at least the second entity, a graphical representation associated with the access to the resource by the first entity.

17. The non-transitory computer-readable medium of claim 16, wherein the one or more instructions, that cause the resource access security system to display the graphical representation, cause the resource access security system to:
display at least a first node associated with the resource, a second node associated with the first entity, and an edge associated with the access to the resource by the first entity.

18. The non-transitory computer-readable medium of claim 15, wherein the one or more instructions further cause the resource access security system to:
obtain a plurality of access logs, wherein the one or more instructions, that cause the resource access security system to perform the security action, cause the resource access security system to:
remove, based on the plurality of access logs, access to the resource by the first entity via at least the second entity.

19. The non-transitory computer-readable medium of claim 15, wherein the one or more instructions, that cause the resource access security system to determine that the one or more access policies permit access to the resource by the first entity via at least the second entity, cause the resource access security system to:
determine that the one or more access policies permit access to the resource by the first entity via at least the second entity and via at least a third entity of the plurality of entities.

20. The non-transitory computer-readable medium of claim 15, wherein the plurality of entities, the plurality of resources, and the one or more access policies are associated with an enterprise, and wherein the one or more instructions, that cause the resource access security system to obtain the plurality of identifiers, the one or more indications of the plurality of resources, and the one or more indications of the one or more access policies, cause the resource access security system to:
obtain the plurality of identifiers, the one or more indications of the plurality of resources, and the one or more indications of the one or more access policies from one or more data sources associated with the enterprise.
